(19) United States
(12) Patent Application Publication
(10) Pub. No.: US 2007/0271311 A1
(43) Pub. Date: Nov. 22, 2007

(54) DISK ARRAY DEVICE AND DATA MANAGEMENT METHOD FOR MANAGING MASTER DATA AND REPLICATION DATA REPLICATED FROM MASTER DATA

(75) Inventors: Masami Ikeda, Tokyo (JP); Haruki Nonaka, Osaka (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/750,003

(22) Filed: May 17, 2007

(30) Foreign Application Priority Data
May 17, 2006 (JP) 2006-137598

(51) Int. Cl. G06F 17/30

(52) U.S. Cl. 707/201

(57) ABSTRACT

An update management table store control section stores an update management table saved in cache memory in a system volume. An update management table return control section saves the update management table stored in system volume in cache memory, upon accepting a device boot-up instruction. An update management table control section updates replication data stored in replication volume for only an update difference indicated by the update management table saved in cache memory.

This application is based upon and claims the benefit of priority from Japanese Patent Application No. 2006-137595 filed on May 17, 2006, the content of which is incorporated by reference.

### BACKGROUND OF THE INVENTION

1. Field of the Invention

The present invention relates to a disk array device and a data management method, and more particularly to a disk array device and a data management method for managing master data and replication data replicated from the master data.

2. Description of the Related Art

Conventionally, various disk array devices have been known.

JP2003-223284A describes a disk array device in which, when a disk unit is added to the disk array device in order to expand the storage capacity of the disk array device, information for expanding the capacity is stored in a non-volatile memory so as to prevent data loss.

JP6-332777A describes a data management system for maintaining the consistency of a database in which a journal file is stored in a non-volatile memory, and data is restored from the journal file when there is a failure such as a power cut.

JP2000-330730A describes a disk array device for storing replication data of master data stored in the master volume into the copy volume.

This disk array device stores an update history table representing the update difference between master data and replication data in cache memory. This disk array device updates only the difference between the master data and the replication data in the master data or the replication data by referring to the update history table, thereby making the contents of the replication data and the contents of the master data consistent.

In the following, a process of making the replication data and the master data consistent is referred to as “mirroring”, and “mirroring” for the second time and beyond is referred to as “re-mirroring”.

JP2003-223284A and JP6-332777A fail to describe the technology for creating the replication data in a short time. On the other hand, the disk array device as described in JP2000-330730A updates only the difference between the master data and the replication data in the master data or in the replication data by referring to the update history table. Therefore, this disk array device can create replication data in a short time.

This disk array device stores the update history table in cache memory. The data in cache memory is deleted if the operation of the disk array device is stopped due to a power cut. Therefore, this disk array device will not have the update history table at the time of re-mirroring after boot-up of the disk array device, and hence will be required to copy the entire master data in the master volume to the copy volume.

Therefore, replication data can not be created in a short time at the time of re-mirroring after boot-up of the disk array device.

### SUMMARY OF THE INVENTION

It is an object of the present invent on to provide a disk array device and a data management method for creating the replication data in a short time at the time of re-mirroring after boot-up of the disk array device.

In order to accomplish the above object, a disk array device according to the invention manages master data updated by a host computer and replication data replicated from the master data.

The disk array device comprises a plurality of disks, a cache memory, a non-volatile storage section, a store control section, a return control section and an information control section.

The plurality of disks comprises a master volume for storing the master data and a replication volume for storing the replication data.

The cache memory stores update difference information representing the update difference between the master data stored in the master volume and the replication data stored in the replication volume.

The store control section stores the update difference information that is stored in the cache memory in the non-volatile storage section.

The return control section stores the update difference information that is stored in the non-volatile storage section in the cache memory upon accepting a start-up instruction indicating the start-up of the disk array device.

The information control section updates only the update difference indicated by the update difference information stored in the cache memory among the replication data stored in the replication volume.

According to the above invention, the disk array device stores the update difference information that is stored in the cache memory in the non-volatile storage section. The disk array device saves the update difference information that is stored in the non-volatile storage section in the cache memory upon accepting the start-up instruction. The disk array device updates only the update difference that is indicated by the update difference information in the cache memory among replication data in the replication volume.

Therefore, even if the update difference information in the cache memory is deleted as the operation of the disk array device is stopped, the update difference information in the non-volatile storage section is saved in the cache memory when the disk array device is started.

Hence, the disk array device can use the update difference information at the time of re-mirroring after boot-up of the disk array device. Therefore, only the update difference in the replication data can be updated at the time of re-mirroring after boot-up of the disk array device. Accordingly, replication data can be created in a short time.

The above disk array device is desirably configured as follows.

Replication data in the replication volume is updated by the host computer. The information control section further updates only the update difference that is indicated by the update difference information in the cache memory among the master data in the master volume.

According to the above invention, the disk array device can use the update difference information at the time of re-mirroring after boot-up of the disk array device. Therefore, only the update difference in the master data can be updated. Accordingly, the replication data can be created in a short time at the time of re-mirroring after boot-up of the disk array device.

The store control section desirably stores the update difference information that is stored in the cache memory in the non-volatile storage section upon accepting a stop instruction indicating that the disk array device is stopped.

According to the above invention, it is possible to prevent the update difference information from being lost as the disk array device is stopped.

It is desirable that the store control section detects whether or not both the master data and the replication data are kept without being changed for a fixed time, and stores the update difference information that is stored in the cache memory in the non-volatile storage section, if both the master data and the replication data are kept without being changed for the fixed time.

According to the above invention, even if the update difference information in the cache memory is lost due to a failure such as a power cut, for example, in a state in which the master data or replication data have not updated for the fixed time, the disk array device can read the update difference information from the non-volatile storage section when the disk array device is started.

Therefore, the disk array device can use the update difference information at the time of re-mirroring after boot-up of the disk array device, and update only the update difference in the master volume.

The above disk array device is desirably configured as follows.

Upon accepting a data update instruction from the host computer, the information control section updates the update difference information in the cache memory and updates the master data in the master volume or the replication data in the replication volume in accordance with the data update instructions. The store control section stores the update difference information in the non-volatile storage section, if the update difference information in the cache memory is updated.

According to the above invention, every time the master data or replication data is updated, the update difference information is stored in the non-volatile storage section.

Therefore, even if the latest update difference information in the cache memory is lost due to a failure of the disk array device, the disk array device can read the latest update difference information from the non-volatile storage section when the disk array device is started.

Accordingly, the disk array device can use the update difference information at the time of re-mirroring after boot-up of the disk array device. Hence, the replication data can be created in a short time at the time of re-mirroring after boot-up of the disk array device.

Also, the plurality of disks may desirably comprise the non-volatile storage section.

According to the above invention, the plurality of disks can be used as the master volume, the replication volume and the non-volatile storage section.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram showing the hardware configuration of a disk array device according to one embodiment of the present invention;

FIG. 2 is a block diagram showing the functional configuration of disk array device 1;

FIG. 3 is an explanatory view showing the state of each volume at the time of replication;

FIG. 4 is an explanatory view showing the state of each volume at the time of replication;

FIG. 5 is an explanatory view showing one example of an update management table;

FIG. 6 is a flowchart for explaining a mirroring operation;

FIG. 7 is a flowchart for explaining the operation at the time writing data;

FIG. 8 is a flowchart for explaining the operation at the time that a device stops;

FIG. 9 is a flowchart for explaining the operation at the time of device boot-up;

FIG. 10 is a flowchart for explaining the task of a monitor a monitor task;

FIG. 11 is a flowchart for explaining a modification of update management table control section 42 and update management table store control section 45; and

FIG. 12 is a flowchart for explaining the modification of update management table control section 42 and update management table store control section 45.

### DETAILED DESCRIPTION OF THE PREFERRED EMBODIMENTS

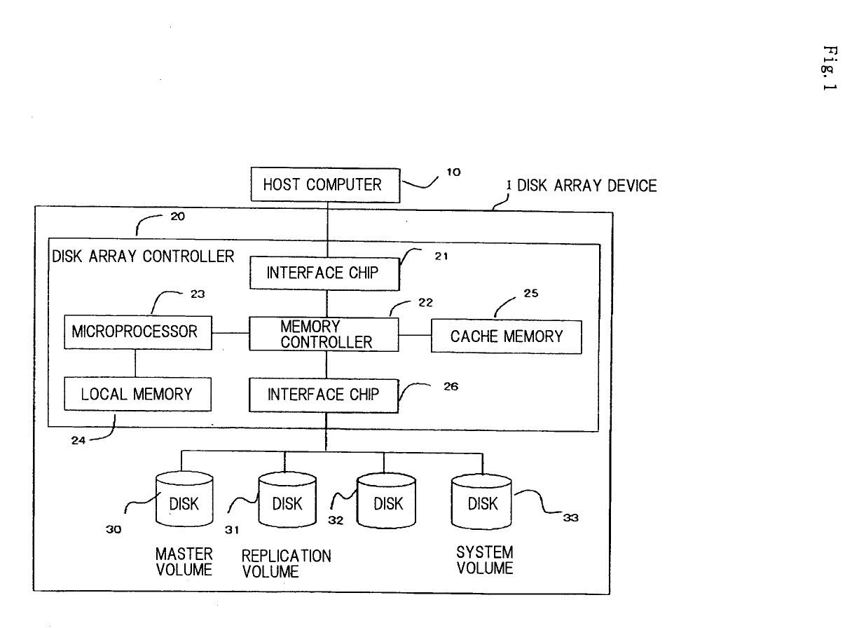

FIG. 1 is a block diagram showing the hardware configuration of a disk array device according to one embodiment of the present invention.

In FIG. 1, disk array device 1 is connected to host computer 10. Disk array device 1 comprises disk array controller 20 and a plurality of disks (drives) 30 to 33.

Disk array controller 20 is provided between host computer 10 and disks 30 to 33. Disk array controller 20 comprises interface chip 21, memory controller 22, microprocessor 23, local memory 24, cache memory 25 and interface chip 26.

Disk 30 is used as a master volume for storing master data updated by host computer 10.

Disk 31 is used as a replication volume for storing replication data replicated from the master data.

Disk 32 stores various kinds of data.

Disk 33 is used as a system volume (non-volatile storage section).

Interface chip 21 is connected to host computer 10, using a global bus such as a SCSI (Small Computer System Interface) or a Fiber Channel.

Interface chip 26 is connected to disks 30 to 33, using a SCSI (Small Computer System Interface) or a universal bus such as a fiber channel.

Cache memory 25 stores read data or write data communicated between interface chips 21 and 26. Also, cache memory 25 stores an update management table (update difference information) that represents an update difference between the master data stored in master volume 30 and the replication data stored in replication volume 31.

Memory controller 22 controls cache memory 25.

Microprocessor 23 generally controls disk array controller 20.

Local memory 24 stores a microcode and control information used in microprocessor 23, for example.

In this embodiment, four disks 30 to 33 are used, but the number of disks is not limited to four, and may be appropriately changed.

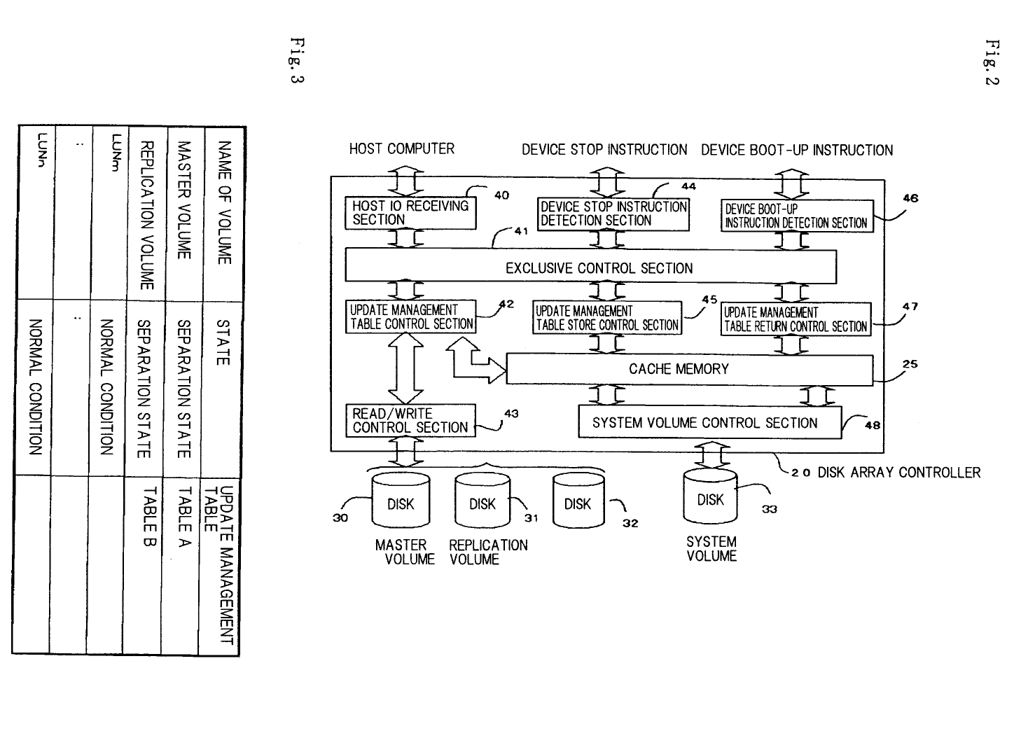

FIG. 2 is a block diagram showing the functional configuration of disk array device 1. In FIGS. 1 and 2, the same sections are denoted by the same reference numerals.

In FIG. 2, disk array controller 20 comprises host IO receiving section (hereinafter simply referred to as “receiving section”) 40, exclusive control section 41, update management table control section (hereinafter simply referred to as “table control section”) 42, read/write control section 43, device stop instruction detection section (hereinafter simply referred to as “detection section”) 44, update management table store control section (hereinafter simply referred to as “store control section”) 45, device boot-up instruction detection section (hereinafter simply referred to as “detection section”) 46, update management table return control section (hereinafter simply referred to as “return control section”) 47, system volume control section 48 and cache memory 25.

Receiving section 40 communicates with host computer 10.

Detection section 44 detects a device stop instruction. The device stop instruction is one example of stop instruction indicating that disk array device 1 has stopped.

Detection section 46 detects a device boot-up instruction. The device boot-up instruction is one example of a start instruction indicating that disk array device 1 has started up.

Read/write control section 43 controls disks 30 to 32.

System volume control section 48 controls system volume 33.

Exclusive control section 41 exclusively controls a host IO process, a process based on the device stop instruction and a process based on the device boot-up instruction.

Table control section 42 controls the reference and update of the update management table in cache memory 25 in performing the host IO process.

Table control section 42 is one example of an information control section, and updates only the update difference indicated by the update management table saved in cache memory 25 among the replication data stored in replication volume 31. Table control section 42 may update only the update difference indicated by the update management table saved in cache memory 25 among the master data stored in master volume 30.

Store control section 45 reads the update management table from cache memory 25, and stores the update management table in system volume 33, using system volume control section 48 in performing the process based on the device stop instruction.

Return control section 4 date management table from system volume 33 using system volume control section 48, and writes the update management table in cache memory 25 in performing the process based on the device boot-up instruction.

The operation will be described below.

First of all, data replication will be described below. Data replication is a function of creating the replication of master volume 30 when disk array device 1 is used by host computer 10.

Disk array device 1 uses disk 30 as master volume 30 for use in host computer 10 and uses disk 31 as replication volume 31 for storing the replication of data in master volume 30.

Master volume 30 and replication volume 31 are divided into plural blocks to manage data in each block. In addition, each block of master volume 30 corresponds one-to-one to each block of replication volume 31.

Disk array controller 20 associates master volume 30 with replication volume 31 in making the data replication.

This association can be made in the following manner, for example.

In a state in which master volume 30 and replication 31 are not associated with each other (separation state), receiving section 40, upon accepting a mirroring instruction from host computer 10, provides the mirroring instruction to exclusive control section 41.

Exclusive control section 41, upon accepting the mirroring instruction, provides the mirroring instruction to table control section 42.

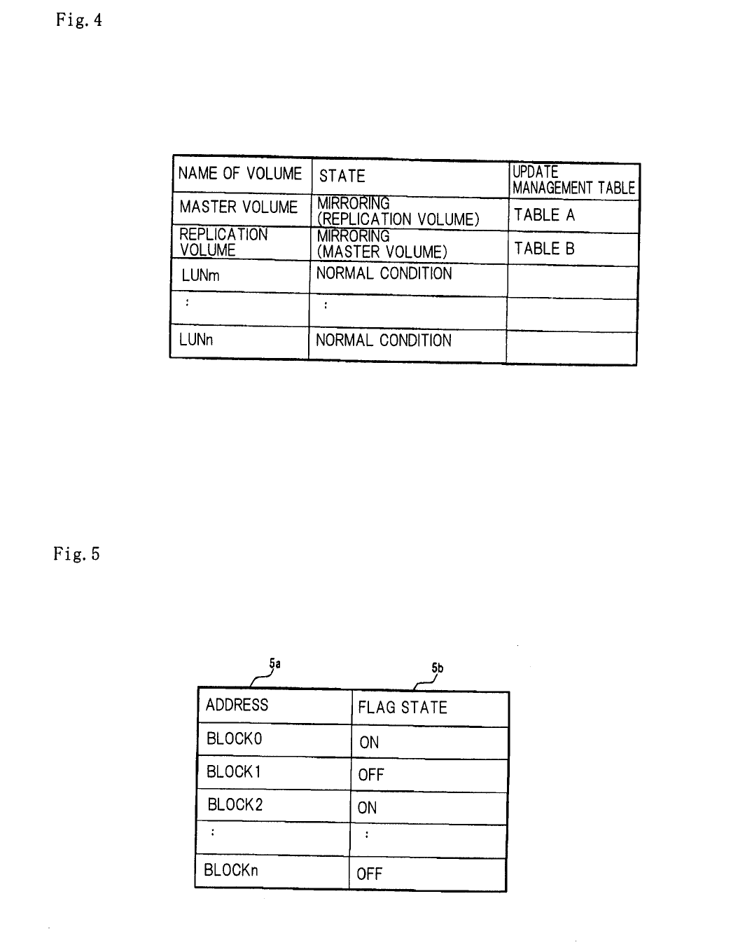

Table control section 42, upon accepting the mirroring instruction, carries out the mirroring process, and then associates master volume 30 and replication volume 31. Owing to this association, the relationship between master volume 30 and replication volume 31 is changed from the state as shown in FIG. 3 to the state as shown in FIG. 4.

At the time of this association, table control section 42 creates an update management table A for master volume 30 and an update management table B for replication volume 31 in cache memory 25.

FIG. 5 is an explanatory view showing one example of the update management table.

In FIG. 5, the update management table has each block (address) in the volume and flag 5b that corresponds to each block.

Table control section 42 turns ON all the flags in update management table A and turns OFF all the flags in update management table B at the first mirroring time (when the mirroring instruction is accepted).

Thereafter, table control section 42 controls read/write control section 43, thereby specifying a block in which the flag is ON in update management table A in cache memory 25, selecting the block in master volume 30 specified by the specified block, copying data in the selected block, and writing the data into the block of replication volume 31 corresponding to the selected block.

In this case, since all the flags in the update management table are ON, table control section 42 copies all the data in master volume 30 to replication volume 31. Therefore, the first mirroring is completed.

Thereafter, receiving section 40, upon accepting a separation instruction from host computer 10, provides the separation instruction to exclusive control section 41.

Exclusive control section 41, upon accepting the separation instruction, provides the separation instruction to table control section 42.

Table control section 42, upon accepting the separation instruction, dissolves the association between master volume 30 and replication volume 31 and separates replication volume 31 from master volume 30 (see FIG. 3).

The data as shown in FIGS. 3 and 4 are saved in cache memory 25 by table control section 42, for example.

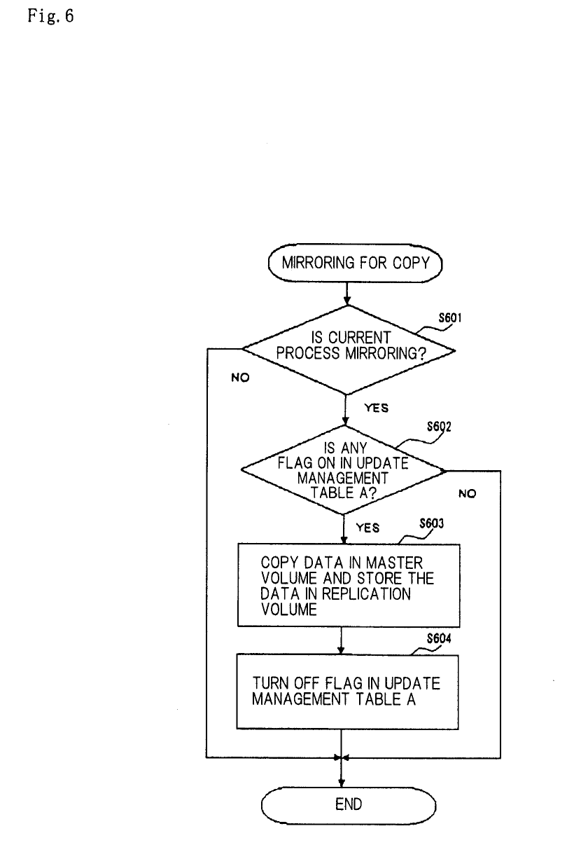

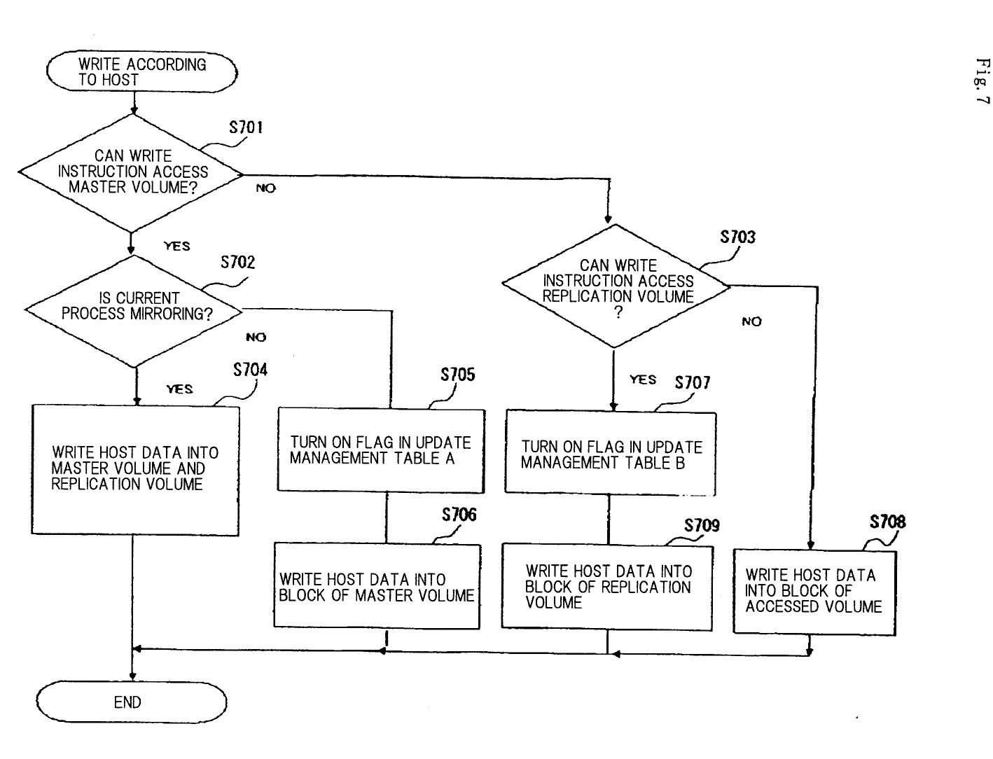

FIG. 6 is a flowchart for explaining a mirroring operation. Referring to FIG. 6, the mirroring operation will be described below.

First of all, at step S601, table control section 42 judges whether or not the current process is mirroring. Table control section 42 performs step S602 if the current process is mirroring, or ends the mirroring operation if the current process is not mirroring.

At step S602, table control section 42 judges whether or not any flag is ON in update management table A. Table control section 42 performs step S603 if any flag is ON in update management table A, or ends the mirroring operation if no flag is ON in update management table A.

At step S603, table control section 42 controls read/write control section 43, thereby specifying the block of master volume 30 in which the flag is ON in update management table A, copying data of the specified block, and writing the data into the block of replication volume 31 corresponding to the specified block. Thereafter, table control section 42 performs step S604.

At step S604, table control section 42 turns OFF the flag in update management table A, and ends the mirroring operation.

FIG. 7 is a flowchart for explaining the operation at the time of data write. Referring to FIG. 7, the operation at the time of data write will be described below.

Receiving section 40, upon accepting a write instruction (including host data) from host computer 10, provides the write instruction to exclusive control section 41. Exclusive control section 41, upon accepting the write instruction, provides the write instruction to table control section 42.

Table control section 42, upon accepting the write instruction, performs step S701.

At step S701, table control section 42 judges whether or not the write instruction is an instruction for accessing master volume 30. Table control section 42 performs step S702 if the write instruction is the instruction for accessing master volume 30, or performs step S703 if the write instruction is not the instruction for accessing master volume 30.

At step S702, table control section 42 judges whether or not the current process is mirroring. Table control section 42 performs step S704 if the current process is mirroring, or performs step S705 if the current process is not mirroring.

At step S704, table control section 42 writes host data into master volume 30 and replication volume 31. Therefore, even if data is written by host computer 10 into master volume 30 during mirroring, the data update is reflected in replication volume 31. Hence, the master data of master volume 30 and the replication data of replication volume 31 are coincident.

At step S705, table control section 42 turns ON the flag corresponding to the block of master volume 30 accessed by host computer 10 among the flags in update management table A. Thereafter, table control section 42 performs step S706.

At step S706, table control section 42 writes the host data into the block of master volume 30 accessed by host computer 10.

On the other hand, at step S703, table control section 42 judges whether or not the write instruction is the instruction for accessing replication volume 31. Table control section 42 performs step S707 if the write instruction is the instruction for accessing replication volume 31, or performs step S708 if the write instruction is not the instruction for accessing replication volume 31.

At step S707, table control section 42 turns ON the flag corresponding to the block of replication volume 31 accessed by host computer 10 among the flags in update management table B. Thereafter, table control section 42 performs step S709.

At step S709, table control section 42 writes the host data into the block of replication volume 31 accessed by host computer 10.

On the other hand, at step S708, table control section 42 writes the host data into the volume (e.g., disk 32) accessed by host computer 10.

Next, the re-mirroring operation will be described below.

Receiving section 40, upon accepting a re-mirroring instruction from host computer 10, provides re-mirroring instructions to exclusive control section 41. Exclusive control section 41, upon accepting the re-mirroring instructions, provides the re-mirroring instructions to table control section 42.

Table control section 42, upon accepting the re-mirroring instruction, carries out the mirroring process, and performs the mirroring operation as shown in FIG. 6.

It is desirable that table control section 42 performs the following operation before ending the mirroring operation as shown in FIG. 6.

Table control section 42 judges whether or not any flag is ON in update management table B.

If any flag is ON in update management table B, table control section 42 controls read/write control section 43, thereby copying data of the block of replication volume 31 in which the flag is ON in update management table B, and writing the data into the block of master volume 30 corresponding to the block in which the flag is ON in update management table B.

Thereafter, table control section 42 turns OFF the flag in update management table B, and ends the mirroring operation.

At the time of re-mirroring, only data of the updated block is copied, because only the flag of the block with data updated host computer 10 is ON among the flags in the update management table. Hence, the data update time can be shortened.

Herein, in the update management table at the time of re-mirroring, only the flag of the block, which is updated when master volume 30 and replication volume 31 are in a state in which they are separated, is ON, and this update management table is saved in cache memory 25.

If disk array device 1 is stopped due to a power cut in a state during which the update management table is saved. In cache memory 25, and thereafter, disk array device 1 is booted up, cache memory 25 is initialized, so that table control section 42 turns ON all the flags of the update management table. If a re-mirroring instruction is made in this state, the entire master data in master volume 30 is copied to replication volume 31.

Thus, disk array device 1 stores the update management table that is stored in cache memory 25 in a system disk area (system volume 33) when disk array device is stopped, to avoid copying the entire master data in master volume 30 when the re-mirroring instruction is made.

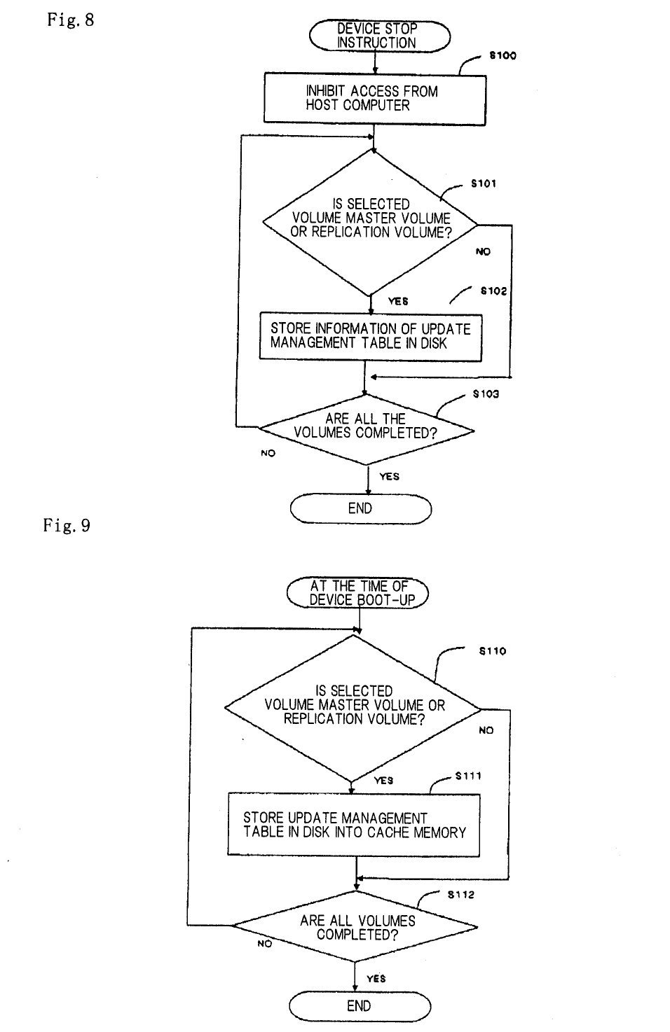

FIG. 8 is a flowchart for explaining the operation at the time that the device stops. Referring to FIG. 8, the device stop operation will be described below.

Detection section 44, upon detecting a device stop instruction, provides the device stop instruction to exclusive control section 41.

Exclusive control section 41, upon accepting the device stop instruction, performs step S100.

At step S100, exclusive control section 41 inhibits access from host computer 10 so that data of master volume 30 and replication volume 31 cannot be updated.

Thereafter, exclusive control section 41 provides the device stop instruction to store control section 45. Store control section 45, upon accepting the device stop instruction, performs step S101.

At step S101, store control section 45 selects one of the volumes mounted on the plurality of disks 30 to 33, and judges whether the volume is master volume or replication volume.

The information (information as shown in FIGS. 3 and 4) for making this judgment is saved in cache memory 25 or local memory 24 as shown in FIG. 1, for example. Store control section 45 reads the information from cache memory 25 or local memory 24 and performs step S101.

Store control section 45 performs step S102 if the volume is master volume or replication volume, or performs step S103 if the volume is neither master volume nor replication volume.

At step S102, store control section 45 reads information of update management table from cache memory 25. Thereafter, store control section 45 controls system volume control section 48, thereby performing a process of storing the information of the update management table, together with the associated information of master volume 30 and replication volume 31, and their states (see FIGS. 3 and 4) in system volume 33. Thereafter, store control section 45 performs step S103.

If the associated information of master volume 30 and replication volume 31 and their states (see FIGS. 3 and 4) are saved in cache memory 25, for example, store control section 45 reads the information from cache memory 25, and controls system volume control section 48 to store the information in system volume 33.

At step S103, store control section 45 judges whether or not step S101 is performed for all the volumes mounted on the plurality of disks 30 to 33. Step S101 is performed if step S101 is not performed for all the volumes, or the operation is ended if step S101 is performed for all the volumes.

FIG. 9 is a flowchart for explaining the operation at the time of device boot-up. Referring to FIG. 9, the device boot-up operation will be described below.

Detection section 46, upon detecting a device boot-up instruction, provides the device boot-up instruction to exclusive control section 41.

Exclusive control section 41, upon accepting the device boot-up instruction, inhibits access from host computer 10 so that data of master volume 30 and replication volume 31 can not be updated.

Thereafter, exclusive control section 41 provides the device boot-up instruction to return control section 47. Return control section 47, upon accepting the device boot-up instruction, performs step S110.

At step S110, return control section 47 selects one of the volumes mounted on the plurality of disks 30 to 33, and judges whether the volume is master volume or replication volume.

The information (e.g., information as shown in FIGS. 3 and 4) for making this judgment is saved in cache memory 25 and local memory 24 as shown in FIG. 1, for example. Store control section 45 reads the information from local memory 24 and performs step S110.

Return control section 47 performs step S111 if the selected volume is master volume or replication volume, and performs step S112 if the volume is neither master volume nor replication volume.

At step S111, return control section 47 controls system volume control section 48, thereby performing a process of reading the associated information of master volume 30 and replication volume 31, their states and the information of the update management table stored in system volume 33, and storing them into cache memory 25. Thereafter, return control section 47 performs step S112.

At step S112, return control section 47 judges whether or not step S110 is performed for all the volumes mounted on the plurality of disks 30 to 33. Step S10 is performed if step S110 is not performed for all the volumes, or the operation is ended if step S110 is performed for all the volumes.

If the reading is all completed, exclusive control section 41 releases an access inhibit state for host computer 10. Therefore, disk array device 1 is enabled for access from host computer 10, and is normally operable.

According to this embodiment, store control section 45 stores the update management table that is stored in cache memory 25 in system volume 33, when the device is stopped, and return control section 47 reads the update management table from system volume 33 and saves the update management table in cache memory 25, when the device is booted up.

Therefore, even if the update management table in cache memory 25 is deleted as the operation of disk array device 1 is stopped, the update management table stored in system volume 33 is saved in cache memory 25 when disk array device 1 is started.

Hence, disk array device 1 can employ the update management table at the time of re-mirroring after boot-up of disk array device 1. Therefore, disk array device 1 can perform the mirroring for only a minimum of copies at the time of re-mirroring after boot-up of disk array device 1, whereby the replication data and/or master data can be created in a short time.

Store control section 45, upon accepting the device stop instruction, stores the update management stored in cache memory 25 in system volume 33 in this embodiment.

In this case, it is possible to prevent the update management table from being lost after disk array device 1 is stopped.

Store control section 45 may further have the following function.

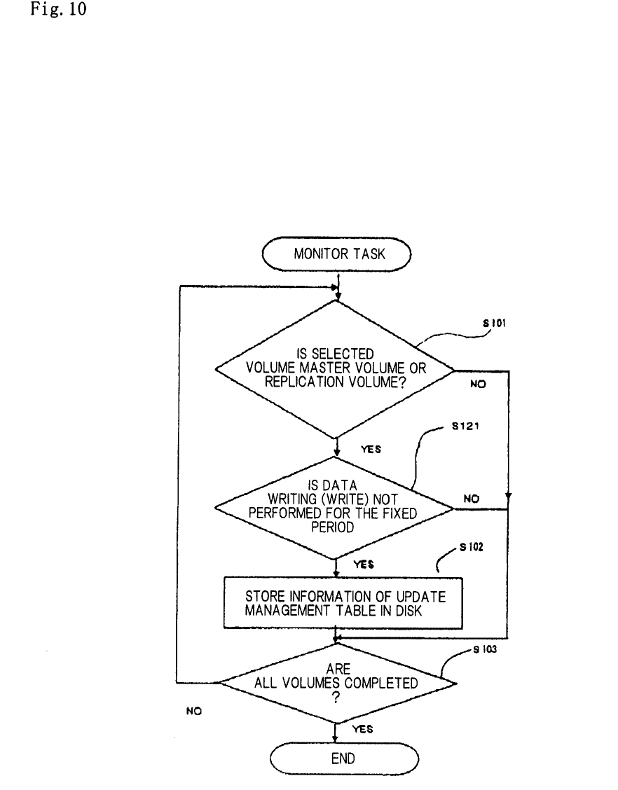

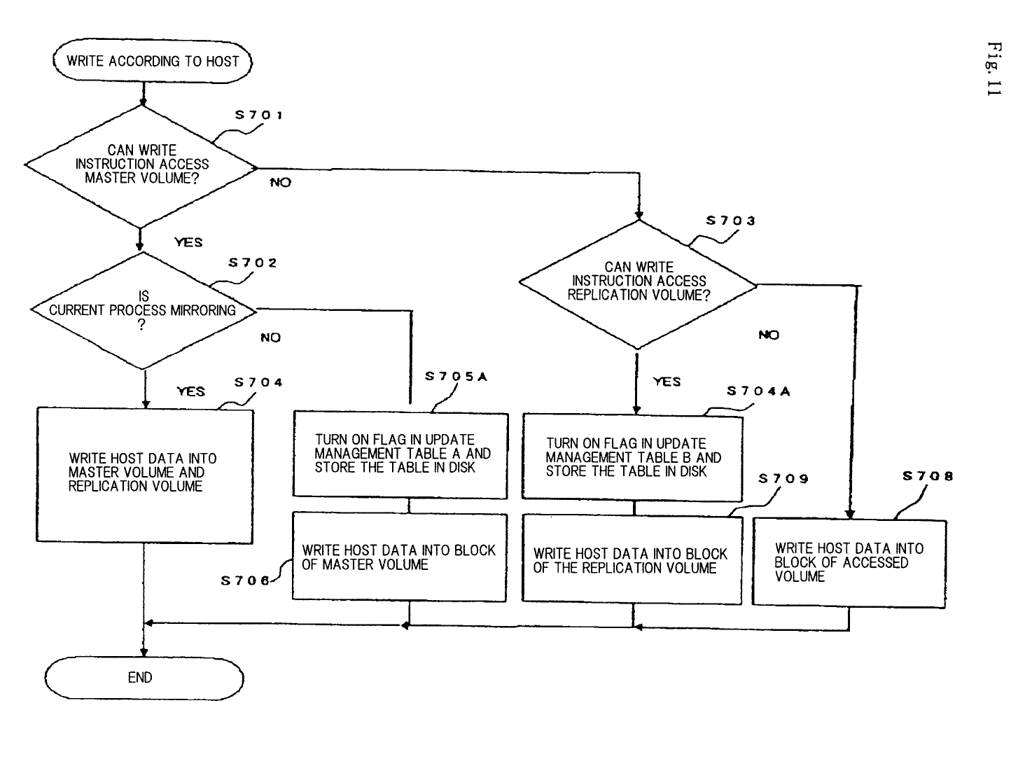

FIG. 10 is a flowchart for explaining an additional function of store control section 45, or specifically, the monitor task of periodically monitoring the state in which the data writing is not performed in master volume 30 or replication volume 31 for a fixed period.

In FIGS. 8 and 10, the same steps are denoted by the same reference signs. The different points of operation from FIG. 8 will be mainly described below.

At steps S101 and S121, store control section 45 periodically monitors the state in which the data writing (write) is not performed in master volume 30 or replication volume 31 for the fixed period.

Store control section 45 performs step S102 to store the information of the update management table at that time in system volume 33 if data writing is not performed in master volume 30 or replication volume 31 for the fixed period.

In this case, even if the update management table in cache memory 25 is lost due to a device failure such as a power cut in a state during which the writing is not done for a long time, the update management table can be read from system volume 33 at the time of device boot-up, and restored to cache memory 25. Therefore, it is possible to perform mirroring for only a minimum of copies at the time of re-mirroring.

At steps S101 and S121, store control section 45 may periodically monitor the state in which the data writing (write) is not performed in master volume 30 and replication volume 31 for a fixed period, and store control section 45 may perform step S102 to store the information of the update management table at that time in system volume 33 if data writing is not performed in master volume 30 and replication volume 31 for the fixed period.

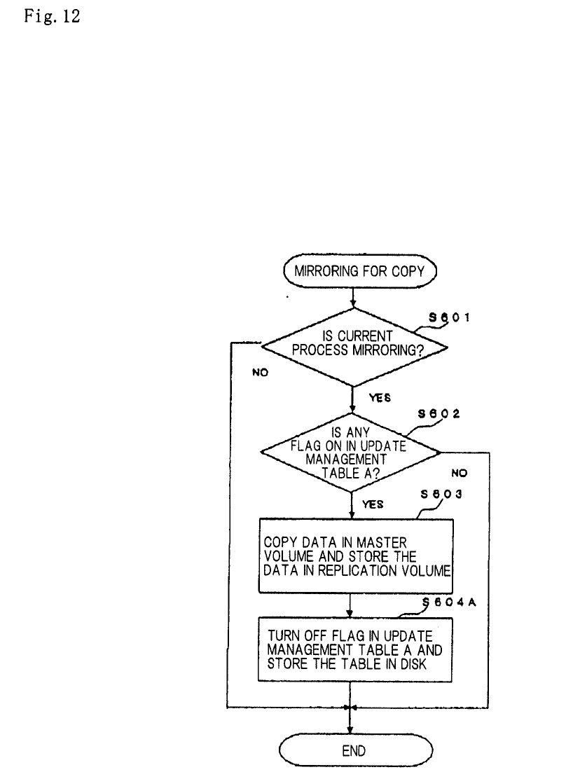

FIGS. 11 and 12 are flowcharts for explaining a modification of table control section 42 and store control section 45.

In FIGS. 7 and 11, the same steps are denoted by the same reference signs. Also, in FIGS. 6 and 12, the same steps are denoted by the same reference signs. The different points of operation from FIGS. 6 and 7 will be mainly described below.

In FIG. 11, step S705A is performed, instead of step 5705 as shown in FIG. 7, and step S707A is performed, instead of step S707 as shown in FIG. 7.

At step S705A, table control section 42 turns ON the flag corresponding to the block of master volume 30 that is accessed by host computer 10 among the flags in update management table A. Thereafter, table control section 42 controls store control section 45 to perform the process of storing the update management table A in system volume 33. Thereafter, table control section 42 performs step S706.

At step S707A, table control section 42 turns ON the flag corresponding to the block of replication volume 31 that is accessed by host computer 10 among the flags in update management table B. Thereafter, table control section 42 controls store control section 45 to perform the process of storing the update management table B in system volume 33. Thereafter, table control section 42 performs step S709.

Also, in FIG. 12, step S604A is performed, instead of step S604 as shown in FIG. 6.

At step S604A, table control section 42 turns OFF the flag of update management table A, then controls store control section 45 to perform the process of storing update management table A in system volume 33, and thereafter ends the mirroring operation.

In this case, every time the flag information of the update management table is updated in a state in which mirroring does not occur, store control section 45 stores the update management table with the flag information updated in system volume 33, and then table control section 42 writes the host data.

Thereafter, even if the update management table in cache memory 25 is lost due to a device failure, the update management table, before the occurrence time of device failure, is stored in system volume 33. Hence, return control section 47 stores the update management table stored in system volume 33 into cache memory 25 in accordance with a procedure as shown in FIG. 9, whereby the update management table in cache memory 25 can be restored to the state before occurrence of device failure.

Accordingly, the replication data can be also created in a short time at the time of re-mirroring after boot-up of disk array device 1.

Moreover, each of the master volume, the replication volume and the system volume is one disk in FIG. 1, but may be the disk constituting a RAID.

Though the update management table is stored in a system volume in FIG. 1, the update management table may be stored in a space area of the disk that is used as the master volume or the replication volume. Also, the update management table may be stored in any other non-volatile memory such as compact flash memory.

While a preferred embodiment of the present invention has been described using specific terms, such description is for illustrative purposes only, and it is to be understood that changes and variations may be made without departing from the spirit or scope of the following claims.

What is claimed is:

1. A disk array device for managing master data updated by a host computer and replication data replicated from said master data, comprising:
a plurality of disks constituting a master volume which stores said master data and a replication volume which stores said replication data;
a cache memory which saves update difference information representing update difference between the master data stored in said master volume and the replication data stored in said replication volume;
a non-volatile storage section;
a store control section which stores said update difference information saved in said cache memory in said non-volatile storage section;
a return control section which saves said update difference information stored in said non-volatile storage section in said cache memory upon accepting a start-up instruction indicating start-up of said disk array device; and
an information control section which updates only said update difference indicated by the update difference information saved in said cache memory among the replication data stored in said replication volume.

2. The disk array device according to claim 1, wherein the replication data stored in said replication volume is updated by said host computer, and said information control section further updates only said update difference indicated by the update difference information saved in said cache memory among the master data stored in said master volume.

3. The disk array device according to claim 1, wherein said store control section stores said update difference information saved in said cache memory in said non-volatile storage section upon accepting a stop instruction indicating that said disk array device is stopped.

4. The disk array device according to claim 1, wherein said store control section detects whether or not both said master data and said replication data are kept without being changed for a fixed time, and stores said update difference information saved in said cache memory in said non-volatile storage section, if both said master data and said replication data are kept without being changed for the fixed time.

5. The disk array device according to claim 2, wherein said information control section updates said update difference information saved in said cache memory, and updates the master data stored in said master volume or the replication data stored in said replication volume, in accordance with a data update instruction, upon accepting said data update instruction from said host computer, and said store control section stores said update difference information in said non-volatile storage section, if the update difference information saved in said cache memory has been updated.

6. The disk array device according to claim 1, wherein said plurality of disks comprise said non-volatile storage section.

7. A data management method for use in a disk array device comprising a non-volatile storage section, a plurality of disks constituting a master volume for storing master data updated by a host computer and a replication volume for storing replication data replicated from said master data and a cache memory for saving update difference information representing an update difference between the master data stored in said master volume and the replication data stored in said replication volume, said method comprising:
a store control step of storing said update difference information saved in said cache memory in said non-volatile storage section;
a return control step of saving said update difference information stored in said non-volatile storage section in said cache memory upon accepting a start-up instruction indicating the start-up of said disk array device; and
an information control step of updating only said update difference indicated by the update difference information saved in said cache memory among the replication data stored in said replication volume.

8. The data management method according to claim 7, wherein the replication data stored in said replication volume is further updated by said host computer, and said information control step further comprises updating only said update difference indicated by the update difference information saved in said cache memory among the master data stored in said master volume.

9. The data management method according to claim 7, wherein said store control step comprises storing said update difference information saved in said cache memory in said non-volatile storage section upon accepting a stop instruction indicating that said disk array device is stopped.

10. The data management method according to claim 7, wherein said store control step comprises detecting whether or not both said master data and said replication data are kept without being changed for a fixed time, and storing said update difference information saved in said cache memory in said non-volatile storage section if both said master data and said replication data are kept without being changed for the fixed time.

11. The data management method according to claim 8, further comprising a step of updating said update difference information saved in said cache memory, and updating the master data stored in said master volume or the replication data stored in said replication volume, in accordance with a data update instruction, upon accepting said data update instruction from said host computer, and said store control step comprises storing said update difference information in said non-volatile storage section, if the update difference information saved in said cache memory has been updated.

12. The data management method according to claim 7, wherein said plurality of disks comprise said non-volatile storage section.

13. A disk array device for managing master data updated by a host computer and replication data replicated from said master data, comprising:
a plurality of disks constituting a master volume for storing said master data and a replication volume for storing said replication data;
a cache memory for storing update difference information representing update difference between the master data stored in said master volume and the replication data stored in said replication volume;
non-volatile storage means;
store control means for storing said update difference information saved in said cache memory in said non-volatile storage means;
return control means for saving said update difference information stored in said non-volatile storage means in said cache memory upon accepting a start-up instruction indicating start-up of said disk array device; and
information control means for updating only said update difference indicated by the update difference information saved in said cache memory among the replication data stored in said replication volume.
